(19) United States
(12) Patent Application Publication
(10) Pub. No.: US 2015/0320250 A1
(43) Pub. Date: Nov. 12, 2015

(54) REAMER

(71) Applicant: ICI USA, LLC, Seattle, WA (US)

(72) Inventors: Matthew Frank, Seattle, WA (US); Ryan Hodgman Peloquin, Seattle, WA (US)

(21) Appl. No.: 14/802,939

(22) Filed: Jul. 17, 2015

Related U.S. Application Data
(63) Continuation of application No. 13/868,434, filed on Apr. 23, 2013.

(51) Int. Cl. A47J 19/02; A23N 1/00

(52) U.S. Cl. CPC A47J 19/02; A23N 1/003

(57) ABSTRACT

A Reamer has a first portion which is at an angle α with respect to a second portion of the blade. Angle α is between 1° and 189°.

### CROSS-REFERENCES TO RELATED APPLICATIONS

This application is a continuation of U.S. patent application Ser. No. 13/868,434 entitled “REAMER” filed on Apr. 23, 2013, which is hereby incorporated by reference in its entirety for all purposes.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### SUMMARY OF THE INVENTION

This invention relates to devices for removing pulp, seeds, and juices from fruits, and more specifically to an improved reamer. Conventional reamers are known to have a generally domed or tapered configuration. The dome or tapered configuration comprises a plurality of blades which extend out convexly from a point adjacent to the crown of the reamer to the base or lower edge. Conventional reamers are shaped this way to press the pulp from the fruit membrane without separating the membranes from the rinds. See Acosta, U.S. Pat. No. 2,944,576, Column 2, lines 26-34 (“Since it is advantageous to remove all of the pulp . . . from the fruit without removing any of the membranes . . . or rag material from the rind, the radial ribs . . . are each rounded to provide a relatively smooth undulated surface on the membranes without tearing or otherwise separating the membrane from the rind”).

Prior art reamers are not efficient in that the ribs push the pulp flat leaving juice in the fruit. Multiple sized reamers are needed to juice fruit of different sizes. Finally, prior art reamers are usually attached to a tabletop holder or a handle. Because of these configurations, multiple reamers are required. This invention addresses these deficiencies.

### BRIEF DESCRIPTION OF THE DRAWINGS

Other features and advantages of the present invention will become apparent in the following detailed descriptions of the preferred embodiment with reference to the accompanying drawings, of which:

FIG. 1 is a perspective view of the reamer;

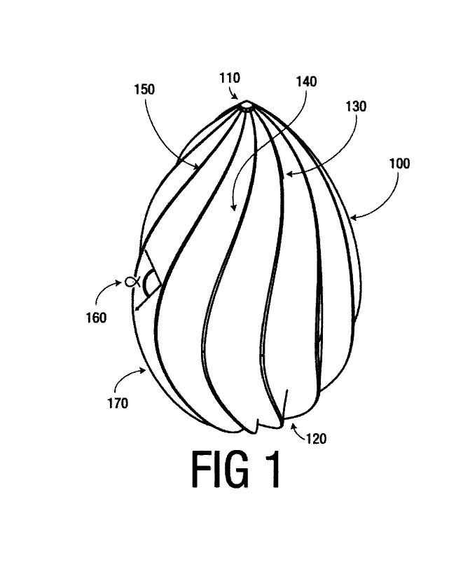

FIG. 2 is a top view of the reamer; the bottom is substantially similar;

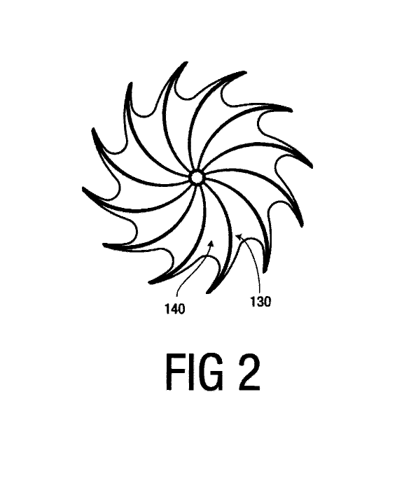

FIG. 3 is a perspective view of the reamer showing how it may be used in a holder;

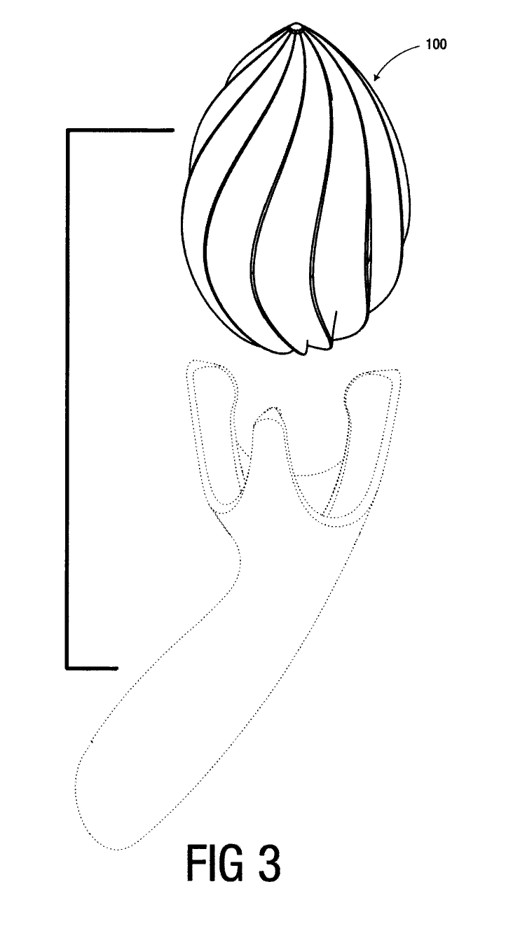

FIG. 4 is a perspective view of the reamer showing how it may be used in a holder.

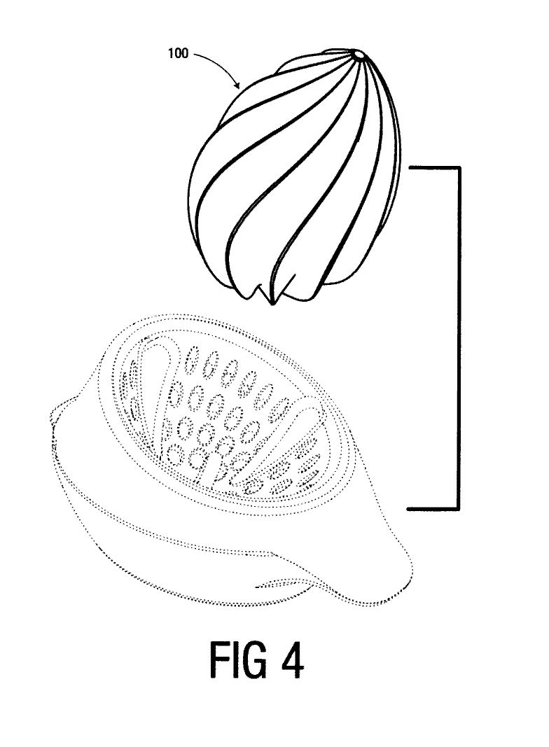

### DETAILED DESCRIPTION OF THE INVENTION

In the description of the invention above and in the detailed description of the invention, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The reamer (100) of the present invention can be used in a manual as well as an automatic juice extracting apparatus. In a preferred embodiment, the reamer (100) comprises a first radius (110) and a second radius (120) where the first radius (110) is smaller than the second radius (120). A plurality of convex blades (130) runs from the first radius (110) to the second radius (120). Each blade (130) has a first portion (150) which is at an angle α (160) with respect to a second portion (170) of the blade (130). Angle α (160) is between 1° and 189°. Each blade (130) is interspersed with deep troughs (140) running from the first radius (110) to the second radius (120). In a preferred embodiment, the first radius (110) and the second radius (120) have an equal diameter.

In a preferred embodiment, the reamer (100) is removeably attached to a handle (200) that allows a user to manipulate the reamer (100). In another preferred embodiment, the reamer (100) is removeably attached to a table top holder (300) that allows the user to manipulate the citrus or fruit over the reamer. Depending on the size of the citrus or fruit, the user may remove and redeploy the reamer (100) onto the handle (200) or table top holder (300) so that the appropriate radius is usable.

What is claimed is:

1. A reamer comprising a plurality of blades where each blade has a first portion which is at an angle α with respect to a second portion of the blade.

2. The reamer of claim 1 further comprises a first radius and a second radius; where each blade convexly runs from the first radius to the second radius; where each blade in interspersed with deep troughs.

3. The reamer of claim 2 where the first radius is equal to the second radius.

4. The reamer of claim 2 where the first radius is smaller than the second radius.

5. The reamer of claim 1 where the angle α is between 1° and 189°.

6. The reamer of claim 1 is removably attached to a handle.

7. The reamer of claim 1 is removably attached to a table top holder.

8. A method to use the reamer of claim 1 comprising placing fruit or citrus on the reamer.
